(19) United States
(12) Patent Application Publication
(10) Pub. No.: US 2013/0219289 A1
(43) Pub. Date: Aug. 22, 2013

(54) Real Transfer by means of electronic devices

(71) Applicant: Blue Media S.A., (US)

(72) Inventors: Andrzej Jerzy Anton, Gdansk (PL); Konrad Pawel Kucharski, Gdynia (PL); Kamil Krzysztof Maras, Gdynia (PL); Maciej Walczak, Gdansk (PL)

(73) Assignee: BLUE MEDIA S.A., Sopot (PL)

(21) Appl. No.: 13/751,156

(22) Filed: Jan. 28, 2013

Related U.S. Application Data
(60) Provisional application No. 61/599,436, filed on Feb. 16, 2012.

(51) Int. Cl. G06F 3/01

(52) U.S. Cl. CPC G06F 3/01
USPC 715/748

(57) ABSTRACT

Real Transfer allows to transfer money or another measurable commodity between two mobile devices, and to visualise this action in a way representing physical decanting of liquid between two vessels. The transfer may be carried out between a mobile device equipped with a mechanism of specifying a position in space (a gyroscope, acceleration sensor) and another mobile device or computer. The funds are transferred by means of a gesture of decanting the liquid from one device to another. On the basis of the position of the device, the speed and quantity of the transferred commodity is specified while the funds are being transferred. Both the sending and the receiving device must be equipped with a mechanism of wireless communication, e.g. WIFI or Bluetooth. The devices must also have access to the Internet in order to ensure connection with the application server.

### CROSS-REFERENCE TO RELATED APPLICATIONS

This application claims the benefit of U.S. Provisional Application No. 61/599,436 filed Feb. 11, 2012.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

Nowadays mobile and electronic technologies begin cross-levelling each other. Users of mobile devices want to have access to technologies with which they will be able to send not only messages and communications between devices, but also commodities. Transferring cash between mobile devices is nowadays one of the main needs of those users.

### BRIEF SUMMARY OF THE INVENTION

The invention allows to transfer commodities between mobile devices. Thanks to using a gyroscope and acceleration sensor it is possible to visualise transfer of commodities, based on laws of physics. It allows to simulate decanting real liquid or pouring another substance (e.g. sand, coins).

### BRIEF DESCRIPTION OF THE SEVERAL VIEWS OF THE DRAWINGS

In order to present and describe in details the functionality and other aspects of the invention, as well as comprehend it, have a look at the following list of graphic drawings:

FIG. 1 Electronic devices with which you can make a Real Transfer.

FIG. 2 The diagram presents the beginning of a Real Transfer process.

FIG. 3 The diagram presents the transfer processing while tilting the electronic device.

FIG. 4 The diagram presents the way of communication between the devices of the Recipient and the Sender during the transfer.

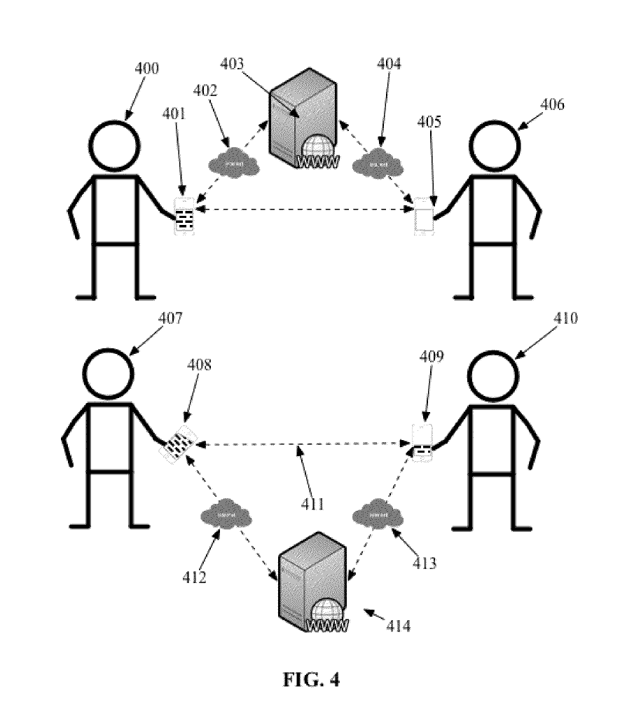

FIG. 5 The diagram presents the way of finishing the transfer.

FIG. 6 The diagram presents the processing at the moment of confirming the transfer of a part of a commodity by the Sender.

FIG. 7 The diagram presents the processing at the moment after confirming the transfer by the Sender.

FIG. 8 The diagram presents the processing at the moment of confirming the transfer of the total quantity of a commodity by the Sender.

FIG. 9 The diagram presents the processing at the moment after annulling the transfer of the total quantity of a commodity by the Sender.

### DETAILED DESCRIPTION OF THE INVENTION

Real transfer allows to transfer money or another measurable commodity between two electronic devices. The transfer may take place between different mobile devices, equipped with a mechanism of specifying the position in space (a gyroscope, acceleration sensor). It is also possible to transfer a commodity from a mobile device to a computer. The devices must be equipped with a mechanism of wireless communication, e.g. WiFi or Bluetooth. The funds are transferred between the users of the system whose devices have a Real Transfer functionality. This functionality must be installed on selected platforms of electronic devices and on the application server, e.g. BlueCash.pl. The electronic devices have software like a client sending appropriate communications to the server. On the basis of the communications received, the server will process the commodity transfer and control the process correctness. Below we present the process of the transfer.

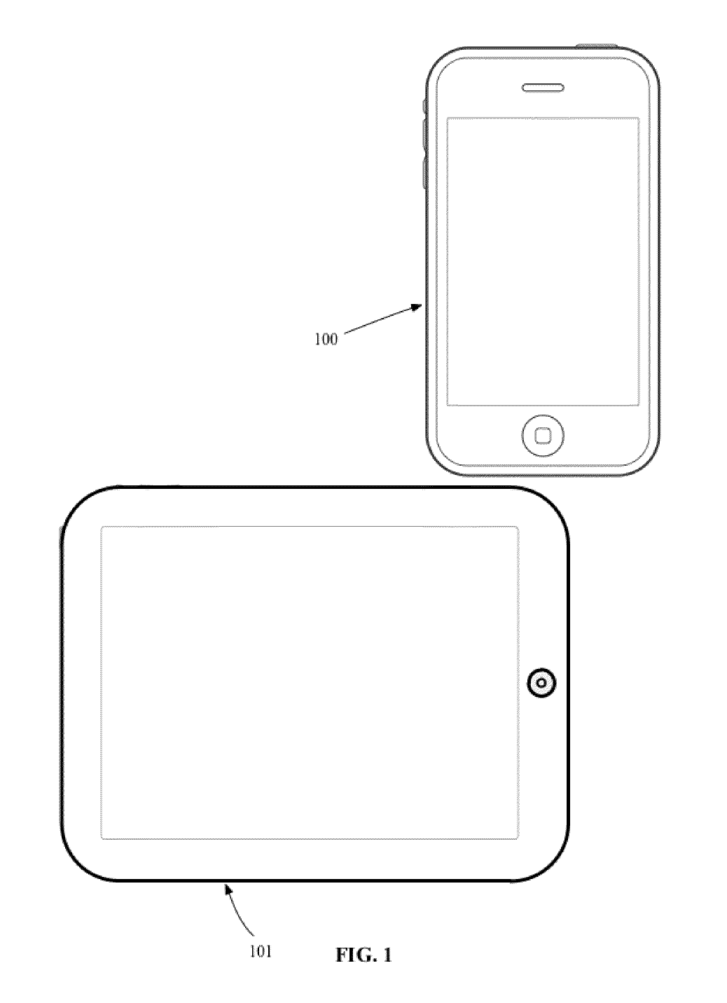

FIG. 1 presents exemplary electronic devices (FIG. 1 100, 101) that may participate in the process of transferring a commodity. These devices are mobile and include phones, tablets e.g. iPhone® or iPad® produced by Apple Inc. of Cupertino, Calif., Samsung Galaxy III made by Samsung Electronics CO., LTD. Two devices participate in the process and they have two roles: the Recipient's device and the Sender's device. The Sender is the person starting the process and wanting to transfer a given commodity to the Recipient. The Recipient is the system user to whom the commodity is sent. The Sender's device must be equipped with a mechanism of specifying the position in space. However, the Recipient's device does not need to have that mechanism. Therefore the Recipient's device may be also a PC, notebook or another device with a Real Transfer mechanism. The devices 100, 101 must be equipped with a screen presenting graphic animation, a module for communicating with the Internet, e.g. a WiFi card, Ethernet card or another mechanism of communicating with the Internet. In order to implement the process, the devices must directly communicate with each other. Therefore the devices must be able to communicate with each other e.g. by means of Bluetooth.

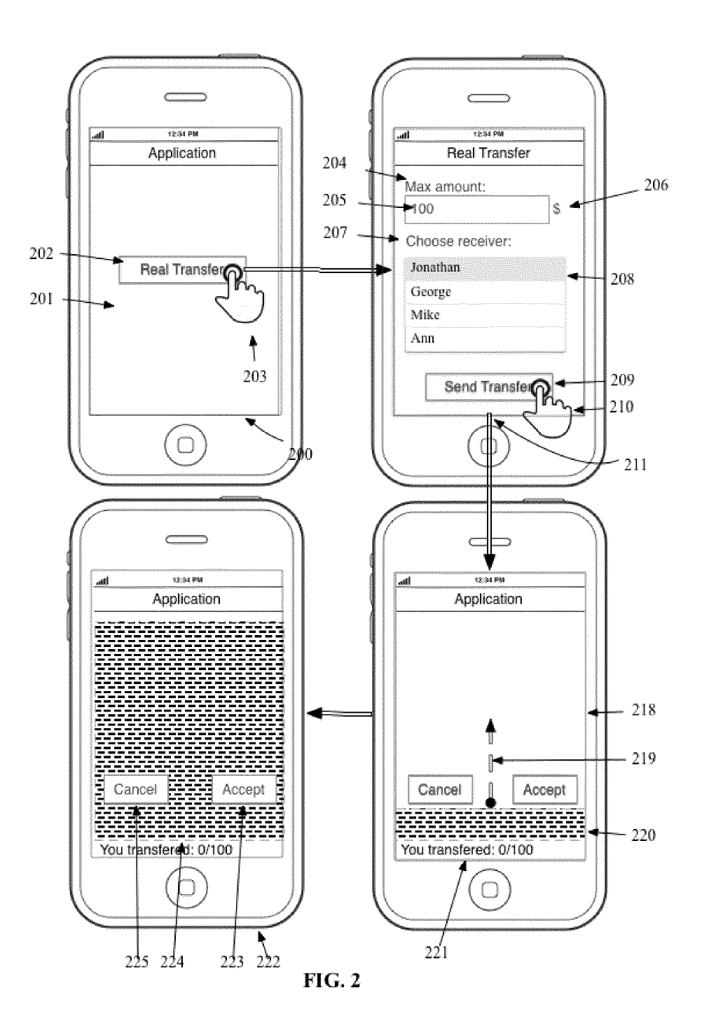

FIG. 2 describes the beginning of a commodity transfer process. The process is started by the Sender. FIG. 200 presents the screen on the Sender's device before starting the process. On his/her working area 201 there is an element 202 allowing to begin the process by touching, pressing or clicking After starting the process, the Sender is transferred to the configuration screen of the process 211. It defines the most important elements required for transferring the commodity. An appropriate field 205 will be prepared on the working area 204, intended to insert an amount of cash or quantity of another commodity chosen by the Sender, which the user will have to complete and indicate a maximal number of the units which he/she wants to transfer to the Recipient. The amount of cash or quantity of another commodity will be inserted by means of a real keyboard attached to the device or a virtual keyboard displayed on the working area. The next element 207, which must be defined by the user, is selecting the Recipient of the transfer. The working area will display the 208 list of devices available nearby, which the Sender's device may communicate with by means of such technologies as Bluetooth 411. Depending on the communication technology and communication platform, an additional setting for connecting those devices may be required. It may happen that in order to connect those devices the communication channel will need to be additionally authorised, e.g. by inserting a number known only to the Sender and the Recipient. After setting the communication channel the Recipient will be informed by means of a channel displayed on his/her device working area, about the start of transferring the commodity to him/her.

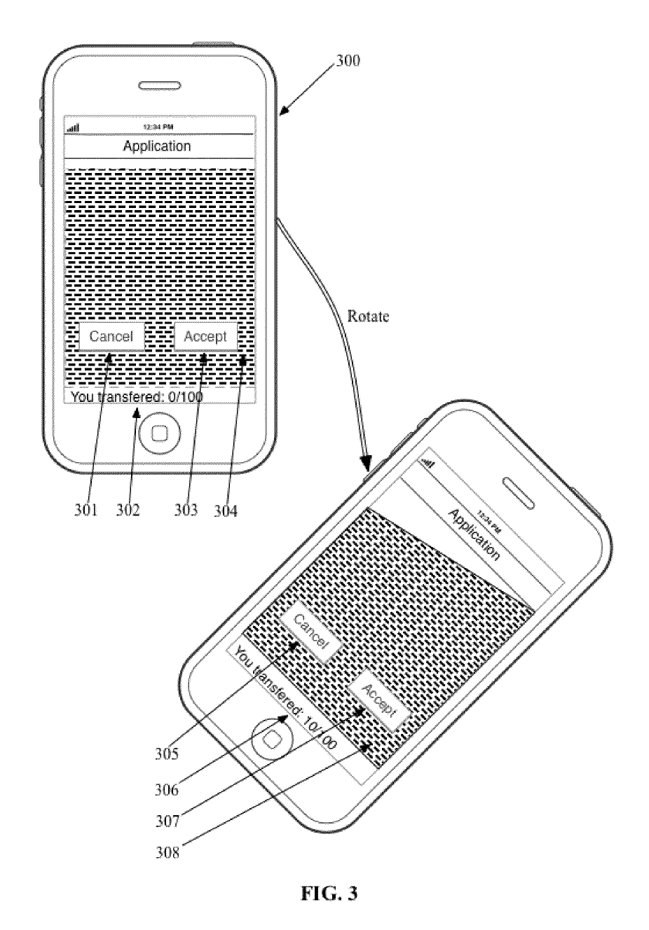

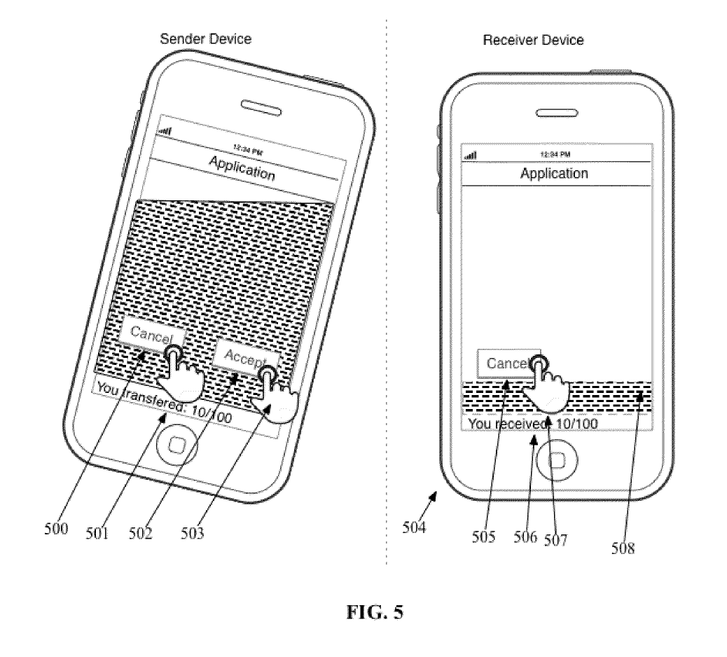

After setting the parameters and communication, the Sender 210 begins transferring the commodity, initiating it with the element 209 on his/her working area. After that action the Recipient's device FIG. 5 504 will display graphics showing a screen not filled with liquid, with the button 505 allowing to annul the process. Returning to FIG. 2 the Sender's device will show animation of filling the screen with liquid or another element representing the commodity 220. The screen will be fully filled with liquid from the bottom to the top. Filling in will be presented as graphics simulating water or other liquid. Optionally the animation may also have different forms, for instance it can be presented as a coin in a box. The filled area 218 will be representing a maximal possible volume to be sent to the Recipient. The direction of filling the screen 219 will be from the bottom to the top of the real device. Already during the filling process, the liquid will be reacting to the natural movement of the device in space and according to its movement it will be turning in line with the data collected from the gyroscope or acceleration sensor. The screen will also display buttons allowing to stop the process 225 and accept the process 223. An additional element displayed on the screens of the Recipient's and the Sender's devices is: for the Sender's device the quantity of the transferred commodity 221 (FIG. 2), 302 or 306 (FIG. 3) and 501 (FIG. 5), and for the Recipient's device, the quantity of the received commodity 506 (FIG. 5).

The way of transferring the commodity is presented in FIG. 3. A user tilting the device makes the liquid 304 tilt. At the moment when the liquid in the natural environment overflows the edge of e.g. a mug, the quantity of liquid on the Sender's screen is reduced. At the same time the Recipient's screen shows increase of the liquid in the same quantity that was reduced on the Sender's screen. The decanted quantity will be displayed on the screen 302 or 306. Turning the Sender's device to a vertical position or the position in which the liquid presented on the screen does not overflow the top end of the device working area, causes the decanting process to stop, i.e. reduction in the quantity of the commodity in the Sender's device is stopped and at the same time its increase in the Recipient's devices is ceased. At the same moment the Recipient, if he/she has a device specifying the position in space, may do the same activity that was previously carried out by the Sender, i.e. may re-transfer the commodity from the Recipient's device to the Sender's device. It will cause that the liquid will increase in the Sender's device and at the same time will decrease in the Recipient's device. Increase and decrease in the liquid quantity will be shown as a graphic change in proportions of the area filled by the liquid against the empty area.

The transfer of the commodity may be annulled at any moment both by the Sender, by means of pressing the button 500 on the screen of the Sender's device, and by the Recipient by means of pressing the button 505 on the screen of the Recipient's device (FIG. 5). When the process is stopped by any Party by means of pressing the button annulling it, the specified quantity of the commodity is not transferred to the users within the system, in particular the cash transfer is not carried out.

Transferring the commodity may be finalised in two ways: by means of pressing by the Sender, while the transferring process is on, the button of accepting the present state of a given amount of cash or quantity of another commodity 502 transferred to the Recipient, even if it is not the whole amount or quantity prepared by the Sender for the transfer and by means of transferring by the Sender the whole amount of cash or quantity of another commodity to the Recipient.

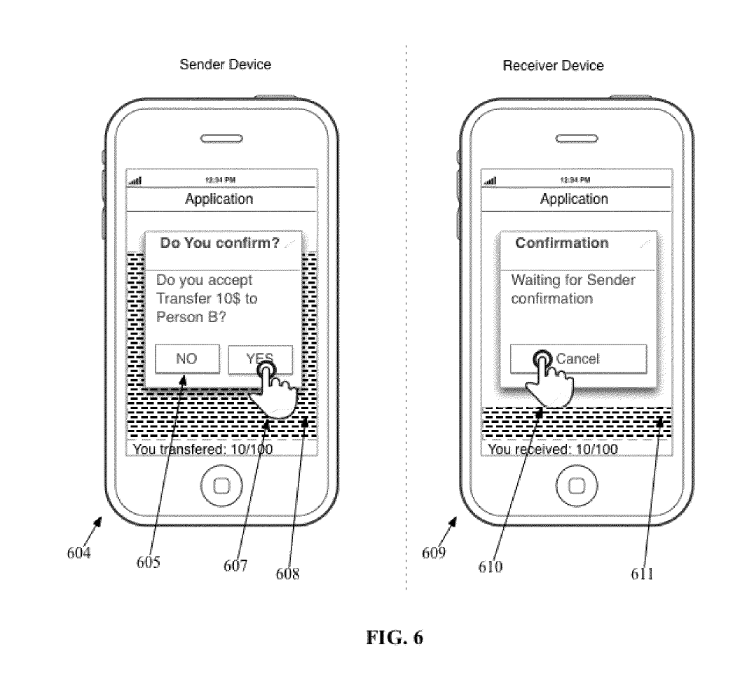

When the Recipient presses the button accepting the present state of the transferred amount of cash or quantity of another commodity 502, the Sender's device will show a screen confirming the operation 605 (FIG. 6). Then the Sender may either confirm transferring the commodity to the Recipient in the present volume by means of pressing the button 607, or to annul the whole process. At the same time the screen of the Recipient's device will display a message stating that the operation is being confirmed by the Sender and until the time of making the decision by the Sender, the Recipient may annul the whole process by means of pressing the button 610.

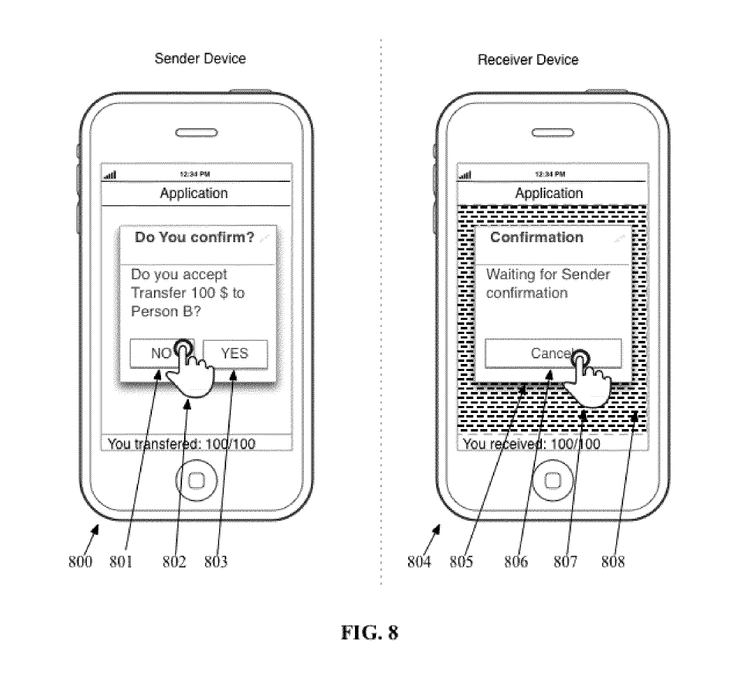

At the moment when the whole liquid (representing the amount of cash or another commodity) is poured between the devices, they will display messages confirming the transfer of the whole amount of cash or quantity of another commodity (FIG. 8). The Sender may confirm the operation clicking the transfer confirmation button 803 or may annul the whole process clicking the transfer rejection button 801. At the same time the screen of the Recipient's device will display a message stating that the operation was confirmed by the Sender 805 and until the Sender makes a decision, the Recipient may annul the whole process by pressing the button 806.

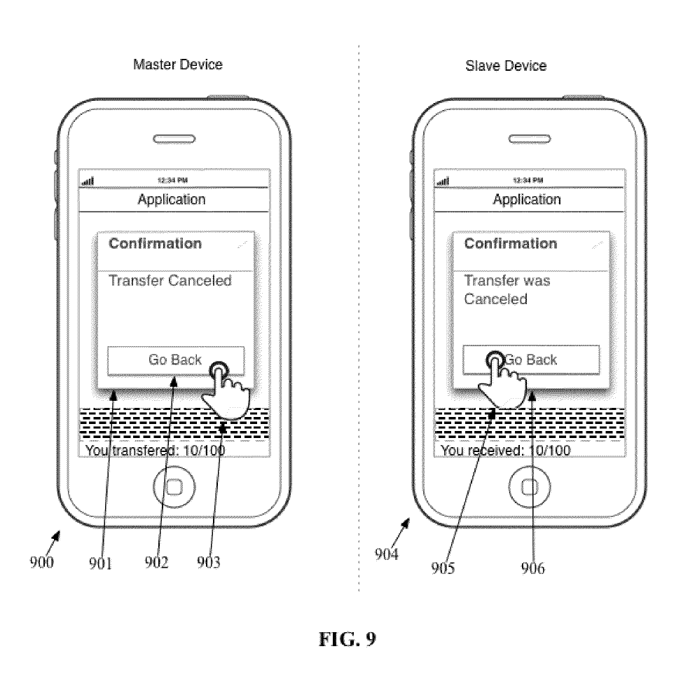

Pressing by any Party the button annulling the operation 500, 505 (FIG. 5) 610 (FIG. 6) or 805 (FIG. 8) or not accepting the operation by the Sender by means of pressing the button 605 (FIG. 6) or 801 (FIG. 8) will annul the whole process and display a message about annulling the process 901 and 906 (FIG. 9) on both devices. Annulling the process does not change anything in the system in which the Sender and the Recipient are users, in particular it will not transfer any commodities from the Sender to the Recipient.

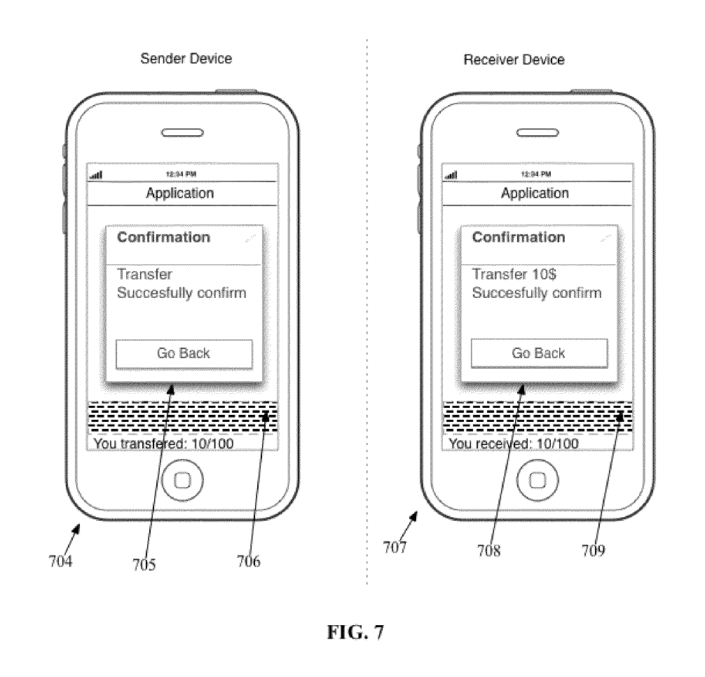

When the Sender accepts the operation and confirms the transfer amount or quantity of another commodity by means of pressing the button 607 (FIG. 6) or 801 (FIG. 8), the Sender's device communicates via the Internet (402, 412) with the system (with the application server 403, 414), which at the same time communicates with the Recipient's device via the Internet (404, 413). When the system verifies correctness of the transfer process and sending the commodity from the Sender to the Recipient, the users are informed via the Internet about successful completion of the transfer and receive confirmation in the form of a message displayed on their devices' screens 705 and 708 (FIG. 7). The Recipient's screen also displays the amount of cash or quantity of another commodity sent to him/her.

Pressing the return buttons on the screens 705, 708 (FIG. 7), 901 or 906 (FIG. 9) will direct the user back to the beginning of the application. Depending on the implemented solution, it may be the last visited place in the application or the start screen 200 (FIG. 2).

### DECLARATION

The Declarations were made on the PTO/AIA/01 forms.

### SEQUENCE LISTING

Not Applicable

What is claimed is:

1. Process of transferring any commodity between one electronic device and another electronic device using a gyroscope or acceleration sensor.

2. Process of transferring any commodity of claim 1; may be transferred to many Recipients.

3. Process of transferring any commodity of claim 1; the Recipient is not required to have a gyroscope or acceleration sensor.

4. Process of transferring any commodity of claim 1; will be presented (visualised) by means of decanting of liquid.

5. Process of transferring any commodity of claim 1; may be simulated (visualised) by means of pouring other things e.g. sand or coins from a box.

6. Process of transferring any commodity of claim 1; may particularly concern transfer of cash.

7. Process of transferring any commodity of claim 1; may concern setting a quantity for a commodity different than money e.g. loyalty points or phone top-up.
